(19) United States
(12) Patent Application Publication
(10) Pub. No.: US 2004/0115390 A1
(43) Pub. Date: Jun. 17, 2004

(54) Fall arrester

(76) Inventors: Ruedi Hess, Tegerfelden (CH); Reto Meier, Zurich (CH); Urs Meyer, Zurich (CH)

Correspondence Address: BURNS DOANE SWECKER & MATHIS L L P, POST OFFICE BOX 1404, ALEXANDRIA, VA, 22313-1404, US

(21) Appl. No.: 10/467,480

(22) PCT Filed: Feb. 4, 2002
(86) PCT No.: PCT/CH02/00058

(30) Foreign Application Priority Data
Feb. 7, 2001 (CH) 217/01

(51) Int. Cl. B32B 3/06

(52) U.S. Cl. 428/99

(57) ABSTRACT

The invention relates to fall arrester for damping a falling body, which substantially comprises a fall arrester element (3) that is linked with connecting elements (1, 2) via load suspension means (1′, 2′). The fall arrester element (3) consists of at least one fiber bundle of a thermoplastic polymer with a stress-elongation behavior that is characterized by a wide elongation range (ε₁, ε₂) in which a substantially continuous force transduction takes place. In a load situation, the fall arrester element (3) is subject to an elongation (ΔL) from the instant when the load builds up to when the falling body comes to a stop. The decisive parameters for designing the fall arrester element (3) are the material used, the elongation behavior thereof and the length and number of fibers from which the material is made. The invention further relates to the use of said fall arrester in safety belts in vehicles, planes, high-speed trains, buses, motor bikes and in mountaineering.

### FIELD OF THE INVENTION

The invention relates to a fall damper according to claim 1 and a method for operation thereof, according to claim 21.

### BACKGROUND OF THE INVENTION

Known fall dampers use different solutions for taking up the impact forces arising during a fall, namely:

{\dot{-}}

interwoven belt bands which are torn apart upon a fall.

{\dot{-}}

a folded-together, sewn band, whose seams tear on being stressed and thus brake the fall,

{\dot{-}}

a cord which is pulled through a carabiner hook upon a fall and is braked by the ensuing friction.

The disadvantage of this set of solutions is that they require a long braking path in order to damp the suspended mass in the fall.

Thus damping systems are known which have in the damping zone a band folded together may times, thus somewhat according to U.S. Pat. No. 5,207,363. In this zone, the band edges are sewn together, so that under the load of the fall the single layers of the band are successively torn loose and a damping effect is attained.

The requirements for a fall damper are laid down, for example in European Standard EN 355 (1992). According to this, in the testing of dynamic performance with a rigid steel mass of 100 kg or a dummy torso of 100 kg, the braking force Fₘₐₓ should not exceed 6.0 kN and the arresting path should not exceed 5.75 m.

The fall damper proposed in the present invention permits a mass of 100 kg as provided for in the European Standard 355 (1992) to be braked on the shortest path. In order to fulfill these standards, the fall damper according to the invention is made with a filament yarn, the force/extension performance corresponds to the requirements for an optimum fall damper.

### SUMMARY OF THE INVENTION

The present invention has as its object to propose a fall damper wherein the braking path takes place on the shortest path and the known disadvantages are thereby remedied. Different uses are indicated.

A further object consists of the description of a method for operating a fall damper.

According to the invention, this object is attained with a fall damper according to the wording of claim 1, with a method according to the wording of claim 21, and uses according to the wording of claims 23-26.

### BRIEF DESCRIPTION OF THE DRAWINGS

The invention is described in detail hereinafter, using the accompanying drawing.

FIG. 1 shows the basic construction of the fall damper according to the invention

FIG. 2 is a schematic diagram of a fall damper under load

FIG. 3 shows the force/extension performance of a filament yarn

FIG. 4 shows the force-extension diagram as the basis of calculation for a fall damping element (idealized)

FIG. 5 shows the force-extension diagram for polypropylene 948f272

FIG. 6A shows a first embodiment example of a fall damper with filament yarn loops

FIG. 6B shows a first embodiment example according to FIG. 6A under load

FIG. 7A shows a known fall damper with connecting means according to EN 363

FIG. 7B shows a second embodiment example of a fall damper without additional connecting means

FIG. 8 shows a third embodiment example of a fall damper with a number of loops of different lengths

FIG. 9 shows a fourth embodiment example of a fall damper with a protective sheath as load-bearing element

FIG. 10 shows a fifth embodiment example of a fall damper with additional yarn loops for increasing the breaking strength

FIG. 11 shows a fifth embodiment example of a fall damper with composite fall damping element.

### DETAILED DESCRIPTION OF THE INVENTION

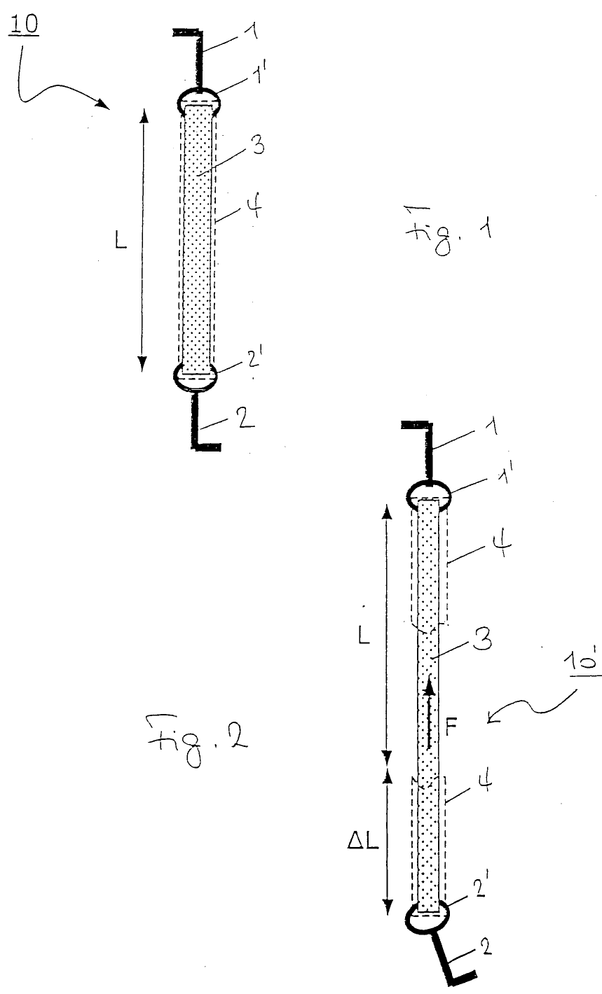

FIG. 1 shows the basic construction of a fall damper according to the invention. The fall damper 10 has a first connecting element 1 at one end, provided for the fixing or suspension of the fall damper at the anchor point. In the lower region, the connecting element 1, with receiving means 1′, receives a fall damping element 3. A second receiving means 2′ is located at the lower end of the fall damping element 3, to which it is connected. A second connecting element 2 is combined with the receiving means 2′ and is provided for fastening the falling body. The fall damping element 3, with a length L, generally consists of a plurality of yarns of a filament yarn specially developed for the fall damper 10.

In order to protect the yarn, or the fall damping element 3, from chafing and UV rays, it is packed into a protective sheath 4. The use of such a sheath is optional.

The fall damping element 3 generally consists of thermoplastic polymers. For the connecting elements 1, 2, carabiner-like parts of plastic, textiles or metal are provided. They can be produced from materials such as, for example, high-strength plastics and yarns or metal alloys.

The receiving means 1′ and 2′ act to fasten the fall damping element to the connecting element. They can be integrated into the connecting means, or be fastened as separate elements to the connecting means, several of which can also be present (e.g., two rings).

The receiving means 1′, 2′ should have no sharp edges (only rounded). They are manufactured from metal, metal alloys, plastics or high-strength fibers. Filament yarn has the property of extending when there is a fall in the fall damper, and of continuously decreasing the resulting force. The properties of the yarn are described later.

The optional protective sheath 4 takes up only minimal, or no, force upon a fall, so that it permits the filament yarn to extend freely.

Practically all the parts of the fall damper are completely or at least partially surrounded by the protective sheath 4, so that only portions of the two connecting elements 1, 2 can be seen from outside. Advantageously several protective sheaths are also used; their distribution to the different functions of the fall damper being determined as mentioned in the Examples.

FIG. 2 shows a schematic diagram of a fall damper 10′ under load. The connecting elements 1, 2 and the receiving means 1′, 2′ correspond to those of FIG. 1. The optional protective sheath 4 has opened, so that the filament yarn 3 can extend unhindered. The properties of the fall damping element 3, e.g., a filament yarn bundle, are designed so that the test standard according to European Standard EN 355 (1992) is best fulfilled. Accordingly, under load, the filament yarn bundle receives a substantially constant force F (≦6 kN) until the test mass (100 kg) is completely stationary. After the braking of the mass, the fall damper has extended by a length ΔL, and remains in this state. The fall damper has to be replaced after being subjected to such a stress.

The fall damping element 3 can be constructed in various ways. The material, the extension performance, the number of fibers, and the length are decisive for its properties. If a combination of loops of various lengths comes to be used as the fall damping element, the properties of the fall damper are given as a superposition.

As materials for the filament yarns, preferably plastics are provided as a fiber bundle. Thus e.g. polypropylene with different extension performance is particularly good for the damping of dynamic forces.

The fall damping element 3 is constructed as a single fiber bundle (loose fibers running parallel), as one or more loops, as a woven, knitted or flocked band, or as a knitted, plaited, doubled, or twisted cord.

The material used has different lengths and/or thicknesses, so that the fall damping element can also be present as a cord core with yarn plaited or woven around it.

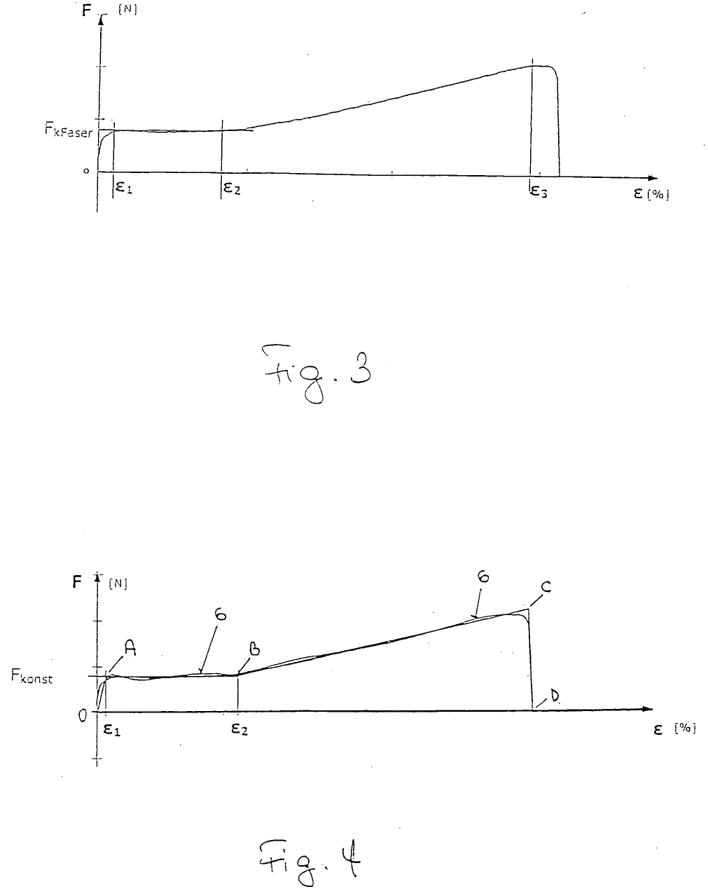

FIG. 3 shows the force/extension performance of a filament yarn.

As the material for the fall damping element, a non-oriented or only partially oriented filament yarn is used (low oriented yarn, LOY, or partially oriented yarn, POY) (Chemical Fiber Lexicon, Hans J. Koslowski, Deutscher Fachverlag, 11th edition, pages 95 and 137 (1997)).

In a first extension region (0, ε₁) of the force/extension characteristic curve, the force uptake builds up quickly. Thereafter the yarn is characterized, in a second extension region (ε₁, ε₂) adjoining the first, by a constant stress uptake up to a value F_{kFiber} over an extension region which is as long as possible. This region is made full use of for the uniform stress uptake of the fall damper. The subsequent rise, up to a multiple of the force, on further extension of the yarn in a third extension region (ε₂, ε₃) adjoining the second prevents the fall damper breaking at high stress. A smooth build-up of the fall speed without resulting damage to the falling body is thereby ensured, and on overload the remaining forces of the arresting impact are taken up until the falling body is stationary.

Optionally, for additional safety reserve, a material, or respectively a loop with tear-resistant yarn (e.g., DYNEMA) with the minimum length L+ΔL (length of the fall damper plus extension length of the fall damper) can be integrated into the fall damper. This prevents breaking of the fall damper even when strongly overloaded.

If a number of similar, loosely assembled yarn fibers or yarn threads are present in a fall damping element, a new force-extension diagram results by superposition of the individual force-extension diagrams, and can be allocated to that of the fall damping element.

The described three extension regions are also valid for the force/extension performance of the fall damping element and are also used hereinafter with the same designations. In this case, the value for F_{kFiber} is of course a multiple of that of the individual fiber.

FIG. 4 shows a force-extension diagram as a calculation basis for a fall damping element (idealized).

The number of fibers required for optimum braking of the mass differs according to the kind of processing (weaving, plaiting, twisting, etc.). If the yarn of the fall damper elements is not further processed, i.e., a loosely assembled fiber bundle is present, the number of the fibers and the extension length of the fall damping element can be determined using the following equations (I), (II) and (III):

n=F_{const}/F_{kFiber} (I)

ΔL=mgh/[(1−ε₁/2ε₂)·n·F_{kFiber-}mg] (II)

Furthermore the required filament yarn length is calculated according to Equation (III):

L=ΔL·100%/ε₂ (III)

where

ΔL [m]=extension length of the fall damper

L [m]=length of the filament yarn for the fall damping element

m [kg]=mass to be caught

g [m/s²]=acceleration due to gravity

h [m]=height of fall of mass to be caught

ε₁ [%]=extension path in % up to constant force progression (FIG. 4)

ε₂ [%]=extension path in % up to additional increase in force (FIG. 4)

Equations II and III are to be understood from the force-extension diagram from FIG. 4. The course of the effective force-extension diagram 6 of FIG. 3 was idealized by straight lines 0-A, A-B, B-C and C-D in order to simplify the calculation. The values calculated on this basis are however on the safe side, since the idealized rise of force runs flatter in the extension region (0, ε1).

FIG. 5 shows a force-extension diagram of polypropylene 948f272, which was used for the first embodiment example.

The polypropylene yarn used with the titer 948f272 has the following force-extension properties (Chemical Fiber Lexicon, Hans J. Koslowski, Deutscher Fachverlag, 11th edition, pages 171-172 (1997)):

The filament yarn builds up a constant force of 3.59 N in the first 8.5% of the extension path, or in the first extension region (0, ε₁). This force remains constant over the further extension—in the second extension region (ε₁, ε₂)—at 80.8%, which corresponds to a total extension of 89.3% of the yarn. Thereafter the force increases in the third extension region (ε₂, ε₃) to 11.36 N at 353% extension. The constant course of the force is used for the fall damping element, and the following increase of force acts as a safety reserve if there is a possible overload of the fall damper.

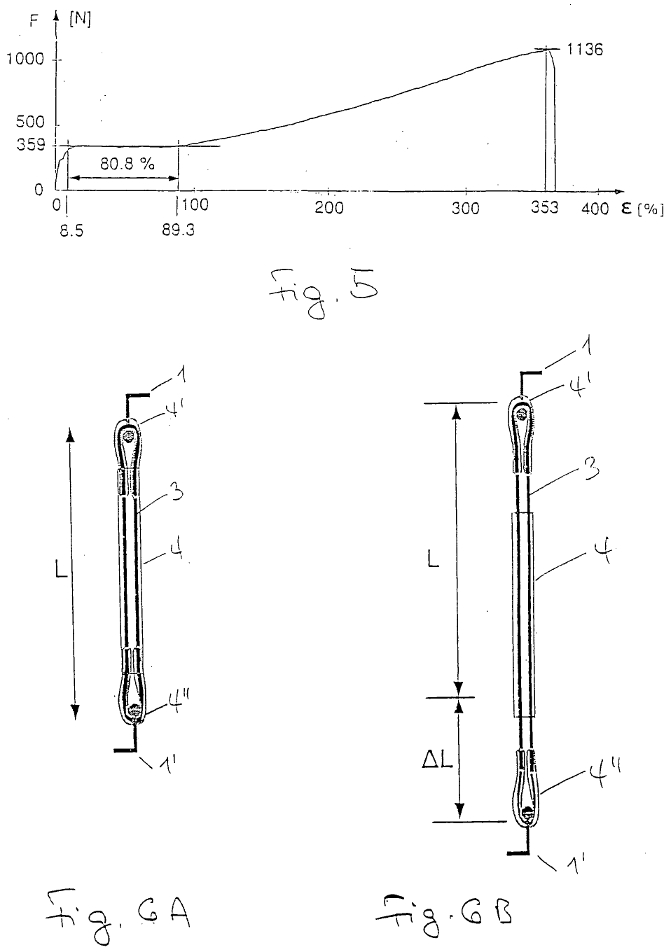

FIGS. 6A and 6B show a first embodiment example of a fall damper with a filament yarn loop, unloaded or respectively under load.

The fall damping element 3 consists of a yarn loop of polypropylene 948f272 with 836 wraps, with a loop periphery of 1.856 m, or L=0.928 m.

An upper and a lower protective sheath 4′, 4″ act to protect the filament yarn against chafing at the connecting points to the upper and lower carabiner hooks 1, 1′. The protective sheaths 4′, 4″ consist of a Duplix 1t flexible tube (Mammut Tec AG, CH-5703 Seon). They are loosely pushed into a middle protective sheath 4, so that upon a fall the filament loops in the fall damper can freely extend (FIG. 6B). The middle protective sheath 4 consists of the same material as the protective sheaths 4′, 4″; however, this is not essential. The carabiner hooks 1, 1′ are manufactured from an aluminum alloy.

The calculation of the fall damping element 3 was performed with Equations (I)-(III) and gave:

From Equation (I): n=1672 fibers with a titer of 948f272

From Equation (II): ΔL=0.829 m

From Equation (III): L=0.928 m

In order to fulfill the test standard for fall dampers according to European Standard EN 355 (1992), namely to brake a mass of 100 kg from [ ]4 m height with max. 6,000 N, the fall damping element specified here has to be made with a bundle of 1,672 fibers of type PP 948f272. The required fiber length is 0.928 m. The mass is braked within a path of 0.829 m by this fall damping element.

This calculation only holds for filament yarn fibers or loops, loosely joined together. If the yarn is woven, plaited or twisted, etc., the number of fibers and the required length of the fall damping element must be calculated in another way.

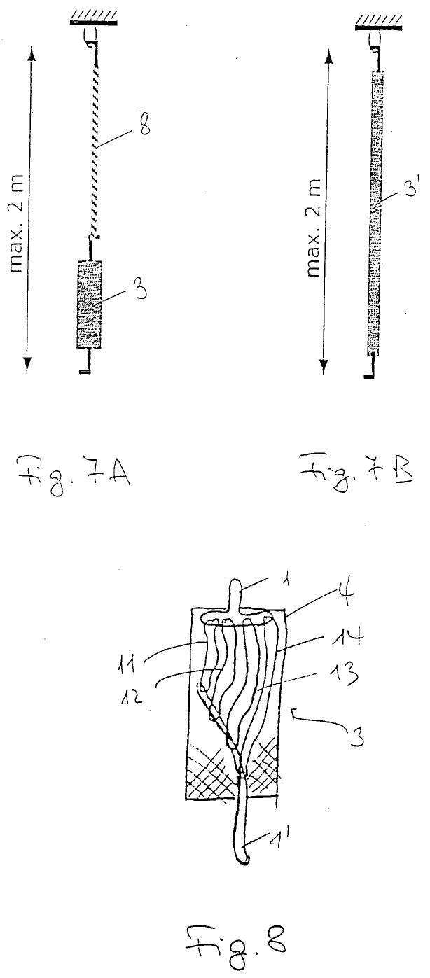

FIG. 7A shows a known fall damper with connecting means according to EN 363. Fall dampers for personal protection equipment (PSA) against falls are used in the arresting systems corresponding to German Industrial Standard (DIN) EN 363. The fall damper 3 (European Standard EN 355) is connected on one side to a arresting belt (European Standard EN 361) and on the other side is suspended on a connecting means or connecting cord 8 (European Standard EN 354) which is fastened to a fixed position. The length of the fall damper including the connecting means should not exceed [ ]2 m.

FIG. 7B shows a second embodiment example of a fall damper without further connecting means.

The two elements of the connecting means or cord (EN 354) and fall damper (EN 355) are united into one element to give a fall damping element 3′.

For the filament yarn of the fall damper in this alternative, a constant course of force over an extension of about 50% is sufficient. Then a fall damper with a length of about 1.50 m is required, in order to brake a body of 100 kg from a height of 4 m. This fall damper is now no longer suspended on a connecting means, but directly fastened to a fixed position or to the anchor point.

FIG. 8 shows a third embodiment example of a fall damper with a number of loops of different length.

The connecting elements 1, 1′ and the protective sheath 4 can be seen. The fall damping element 3 is formed here by four yarn loops 11-14, which have a slightly increasing length. While each individual yarn loop has a force/extension performance according to FIG. 3, the force/extension performance of the fall damping element 3 shows a “staircase-like” course in the second extension region, which in fact provides substantially constant stress uptake.

The yarn loops are extended in a series in a load dropping, without, however, tearing.

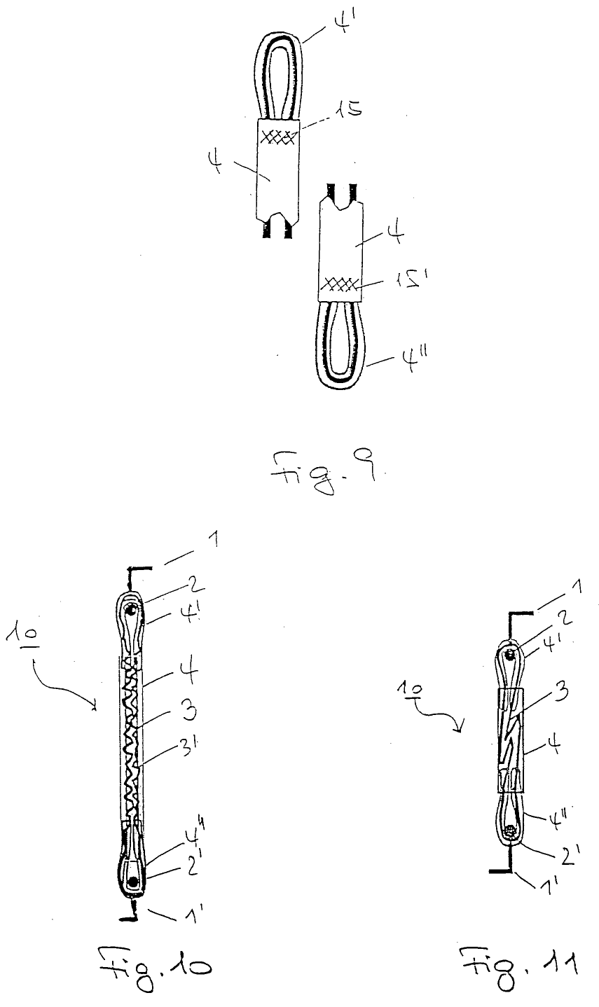

FIG. 9 shows a fourth embodiment example of a fall damper with a protective sheath as a load-bearing element, in a partial view.

So that no permanent lengthening occurs of the fall damper at a pre-load of 2.0 kN (Test Standard for Static Pre-Loading, EN 355), the middle protective sheath 4 is sewn together with the upper and lower protective sheaths 4′, 4″ by means of the seams 15, 15′. The seam is designed so that up to a static load of 2.0 kN it does not break, but however yields or tears under a force of 6.0 kN in a dynamic arrest impact.

As the upper and lower protective sheaths, e.g. a flexible tube of the type Duplix 2t (Mammut Tec AG) can be used. For the middle protective sheath, e.g., a flexible tube of the type Duplix 3t (Mammut Tec AG) can be used. The seam consists of polyester yarn. The remaining structure corresponds to FIG. 1.

The protective sheaths are pushed oppositely against each other, welded, adhered or seamed, whereby the protective sheath(s) receive an at least partial load-bearing function. Under a dynamic load, this leads to separation of the protective sheaths, while in the static case the forces are taken up by the protective sheaths, without a separation occurring.

In a fall, the upper and/or lower protective sheaths 4′ and 4″ are torn out of the middle protective sheath 4. The assembled filament yarn bundle 3 is pulled out of the protective sheath 4 and is unfolded to its full length. Thereafter the fall damper begins to continuously decrease the arresting impact. The protective sheaths can also be made of elastic or partially elastic materials. The protective sheaths thereby become a load-bearing element, which distinguishes this example.

FIG. 10 shows a fifth embodiment example of a fall damper with additional yarn loops for increasing the tear strength.

For additional safety against tearing apart of the fall damper, a second yarn 3′ with higher breaking strength is integrated into the fall damping element 3. As an example, a DYNEEMA yarn or a KEVLAR fiber, or a p-Aramid fiber can be used (Chemical Fiber Lexicon, Hans J. Koslowski, Deutscher Fachverlag, 11th edition, page 88 (1997)). 70 yarns or 35 turns with this yarn first tear at a force of about 25 kN. So that the continuous braking of the body by the filament yarn loops 3 is not prevented by the additional loops before the complete stopping of the body, the firmer yarn loop 3′ needs the following minimum length: L(Gmin)=L+ΔL (=length of the fall damping element+extension length of the fall damper).

The proportion of the selected high-strength fiber material can be up to 50%. Furthermore, polyamide, polyester and p-Aramid are preferably used, these materials having in particular a different breaking extension.

FIG. 11 shows a sixth embodiment example of a fall damper with assembled fall damping element.

So that the length of the fall damper 10 does not have to correspond to the required length of the filament yarn for optimum braking of a body, the fall damping element 3 can be assembled within the protective sheath 4. An advantageous shortening and a compact packet of the fall damping element is thereby attained. As previously described, the carabiner hooks 1, 1′ as connecting elements, the receiving means 2, 2′, the upper and lower protective sheaths 4′, 4″, and the middle protective sheath 4 can be seen.

A method for operation of a fall damper according to the invention is described hereinafter with reference to FIG. 3. In the case of normal load dropping, the arresting impact is substantially taken up by the fall damping element 3 in the first and second extension regions (0, ε₁; ε₁, ε₂). “Normal” means that the load corresponds to the specified values of the relevant standards. In the overload case, in the third extension region (ε₂, ε₃), forces of the arrest impact which are possibly still remaining are taken up, or braked, until the falling body is stationary. “Overload case” means that the load is above the specified values of relevant standards. In an extreme overload case, after the third extension region (ε₂, ε₃), the remaining forces are taken up by the allotment of the additional high-strength fiber materials. “Extreme overload” refers to a load which is far outside the standards, but for which a safety reserve is still provided.

If a fall damping element with elastic or at least partially elastic properties is present during load dropping, the fall damping element will be completely or partially deformed after the extension caused by the load.

Uses of such fall dampers are found as safety belts in vehicles, in that the collision force of a human body is provided for by a belt, band or other restraining element connected to the fall damper.

A fall damping element of the kind described, for example, in a belt restraining system in motor vehicles, arrests the forward-colliding body mass with a predefined force. It is thus suitable for damping the collision forces on a safety belt or on an airbag.

There are further uses in connection with safety belts in aircraft, high-performance trains, buses and motorcycles, and also in connection with emergency restraining systems; likewise as additional damping elements of the falling force in jump nets, and also in mountain sports, together with a cord as an additional damping element for rock climbing and ice climbing.

For damping forces which arise as shocks, as is the case in rock climbing and ice climbing, only a short portion of the extension path, or respectively of the extension element, is required. The fall damping element can thus be provided for multiple, short-term stresses.

1. Fall damper for damping a falling body, wherein it has at one end a connecting element (1) for mounting the fall damper (10) at the anchor point; wherein the first connecting element (1) has a first receiving means (1′) which acts to fasten a fall damping element (3) of thermoplastic polymer to the connecting element (1); wherein at the other end of the fall damper (10) a second connecting element (2) with a second receiving means (2′) is provided and likewise acts to fasten the fall damping element (3); wherein the second connecting element (2) is provided for mounting the body; wherein the fall damping element (3) in the case of load dropping is distinguished by a rapid force uptake in a first extension region (0, ε₁), has a substantially constant force uptake in a second extension region (ε₁, ε₂) adjoining the first, and has a substantially rising force uptake in a third extension region (ε₂, ε₃) adjoining the second and ensuring a smooth buildup of the falling speed without damaging consequences for the falling body and which, when there is an overload, takes up the remaining forces of the arrest impact up to a stationary state of the falling body, the extension lengths of the fall damping element (3) being given by a path (ΔL).

2. Fall damper according to claim 1, wherein the thermoplastic polymer consists of a filament yarn, preferably of polypropylene.

3. Fall damper according to claim 1, wherein the thermoplastic polymer consists of a monofilament polyester or polyamide, which has elastic or at least partially elastic properties.

4. Fall damper according to one of claims 1-3, wherein the fall damping element (3) consists of a textile or plastic-like material.

5. Fall damper according to one of claims 1-4, wherein the fall damping element (3) is present as an individual fiber bundle, as a loop, woven as a band, as a knitted, doubled, plaited or twisted cord.

6. Fall damper according to one of claims 1-5, wherein the fall damping element (3) has a number of loops or a fiber bundle of a synthetic material with different lengths and/or thicknesses.

7. Fall damper according to one of claims 1-6, wherein the fall damping element (3) is surrounded by at least one protective sheath (4), so that only the two connecting elements (1, 2) are visible from the outside.

8. Fall damper according to one of claims 1-7, wherein the fall damping element (3) is present as a fiber bundle or at least one loop, which is surrounded by at least one protective sheath (4, 4′, 4″).

9. Fall damper according to one of claims 1-8, wherein the fall damping element (3) is plaited around or woven around, as a cord core.

10. Fall damper according to one of claims 1-9, wherein the fall damping element (3) consists of a filament yarn bundle having a proportion of up to 50% of a particularly high-strength fiber material such as preferably polyamide, polyester and p-Aramid, the last material in particular having a different breaking extension.

11. Fall damper according to one of claims 1-10, wherein the fall damping element (3) in the allotted length is present, limited to a preselected extension length by a high-strength material, preferably metallic or high-strength fibers.

12. Fall damper according to one of claims 1-11, wherein the fall damping element (3) in a belt restraining system in vehicles arrests the body mass colliding forward with a predefined force and is thereby provided for the damping of the collision forces on the safety belt or the airbag.

13. Fall damper according to one of claims 1-12, wherein the fall damping element (3) is twisted, plaited, knitted or woven as a cord or band.

14. Fall damper according to one of claims 1-13, wherein the fall damping element (3) is constituted as a core element having a protective sheath plaited, knitted or woven around it.

15. Fall damper according to one of claims 1-14, wherein the receiving means (1′, 2′) is integrated into the connecting element (1, 2) or is respectively fastened as at least one separate element to the connecting element (1, 2).

16. Fall damper according to one of claims 1-15, wherein the receiving means (1′, 2′) has rounded edges and is manufactured of metal, metal alloys, plastic, or high-strength fibers.

17. Fall damper according to one of claims 1-16, wherein the connecting elements (1, 2) and the receiving means (1′, 2′) consist of textile, plastic-like, or metallic materials.

18. Fall damper according to one of claims 1-17, wherein the path (ΔL) for a fiber bundle is given by the relationship according to Equations (I), (II) and (III):
n=F_{const}/F_{kFiber} (I)
ΔL=mgh/[(1−ε₁/2ε₂)·n·F_{kFiber-}mg] (II)
L=ΔL·100%/ε₂ (III)
where
ΔL [m]=extension length of the fall damper
L [m]=length of the filament yarn for the fall damping element
m [kg]=mass to be caught
g [m/s²]=acceleration due to gravity
h [m]=height of fall of mass to be caught
ε₁ [%]=extension path in % up to constant force progression
ε₂ [%]=extension path in % up to additional increase in force

19. Fall damper according to one of claims 1-18, wherein it acts to damp forces which arise as shocks, as is the case in rock climbing and ice climbing, so that only a small portion of the extension path, or respectively of the extension element, is required, and wherein it is provided for multiple, short-term stresses.

20. Fall damper according to one of claims 1-19, wherein it is surrounded by an elastic or partially elastic protective sheath (4, 4′, 4″), which is extended to the maximum extension length and then forms a load-bearing element for arresting the still remaining forces.

21. Method of operation of a fall damper according to one of claims 1-19, characterized in that in the normal load dropping case, the arresting impact is substantially taken up by the fall damping element (3) in the first and second extension regions (0, ε₁; ε₁, ε₂) of the arrest impact; and in the overload case, in the third extension region (ε₁, ε₂), the forces of the arrest impact which are possibly still remaining are taken up, or braked, until the falling body is stationary; or, in the extreme overload case, after the third extension region (ε₂, ε₃), the remaining forces are taken up by an allotment of additional high-strength fiber materials.

22. Method according to claim 21, wherein, in the presence of a fall damping element (3) with elastic or at least partially elastic properties, during load dropping the fall damping element is completely or partially deformed.

23. Use of the fall damper according to one of claims 1-19 in connection with safety belts in vehicles.

24. Use of the fall damper according to one of claims 1-19 in connection with safety belts in aircraft, high performance trains, buses and motorcycles.

25. Use of the fall damper according to one of claims 1-19 in connection with emergency restraint systems for cushioning on aircraft and in motor vehicles.

26. Use of the fall damper according to one of claims 1-19 in mountain sports.
